(19) United States
(12) Patent Application Publication
(10) Pub. No.: US 2009/0188344 A1
(43) Pub. Date: Jul. 30, 2009

(54) HANDLEBAR

(76) Inventor: Timothy Tamcsin, St. Paul, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/762,935

(22) Filed: Jun. 14, 2007

(51) Int. Cl. B62K 21/12

(52) U.S. Cl. 74/551.4

(57) ABSTRACT

An adjustable handlebar for motorcycles and other vehicles where the angle of the handlebar relative to the rider can be quickly and easily adjusted and stay in position during the normal forces of use. The handlebar has an offset angled collet with flat sides which engage flat sides on the inside diameter of a tapered head on the top of the vertical portion of the handlebar. The collet can be removed, repositioned and reinserted to different positions in the tapered head to change the horizontal angles of the horizontal portion of the handlebar for the desired riding position and to hold the handlebar in position such that it will not move under normal forces encountered when riding.

### BACKGROUND OF THE INVENTION

1. Field of the Invention

This invention relates to handlebars and more particularly to adjusting the angle of motorcycle handlebars from horizontal and predetermined angles above or below horizontal.

2. Description of the Related Art

Bicycles, motorcycles and other vehicles with handlebars used for steering have handlebars which are adjustable for height and angle from the center line of the vehicle. Handlebars are also angularly adjustable from being horizontal. In some angularly adjustable handlebars, the angle from the horizontal may be hard to select and difficult to maintain. It is desirable to have a horizontally adjustable handlebar wherein the angle is quickly, easily and securely set.

### SUMMARY OF THE INVENTION

The handlebar is easily adjusted to any desired position and fixed in that position so that it will not slip out of position by putting a large force on the handlebar.

The height of the handlebar is changed by use of a split ring clamp on the vertical portion of the handlebar. Similarly, the angle from the center line of the vehicle is controlled by the same split ring clamp. The angle of the horizontal portion of the handlebar is controlled by a collet inserted inside the vertical column's head. The inside of this head is tapered and has a plurality of flat surfaces aligned on the inside diameter of a head. The head holds a collet having flat surfaces matching the flat surfaces of the inside diameter of the head. The collet has an aperture angled offset from the collet horizontal axis such that angular alignment at different positions in the head angularly selects the handlebar horizontal portion relative to a horizontal axis of the vehicle. The flat surfaces of the collet and the inside diameter of the head lock the handlebar angularly in place.

### OBJECTS OF THE INVENTION

It is an object of the invention to provide a fixed angle of a handlebar relative to the horizontal.

It is an object of the invention to quickly and easily adjust the angular position of the handlebars from the horizontal.

It is an object of the invention to quickly and easily adjust the height of the handlebars.

It is an object of the invention to quickly and easily adjust the angular position of the handlebars from the center line of the vehicle.

It is an object of the invention to prevent the position of the handlebars to be displaced during use after initial setting.

Other objects, advantages and novel features of the present invention will become apparent from the following description of the preferred embodiments when considered in conjunction with the accompanying drawings.

### BRIEF DESCRIPTION OF THE DRAWINGS

FIG. 1 is a perspective view of the assembled handlebar.

FIG. 2 is a perspective view of the tapered head of the vertical portion of the handlebar.

FIG. 3 is a perspective view of the collet with an angular offset aperture for engaging a handlebar and flat outer diameter sides for engaging the inside of the vertical portion's head.

FIG. 4 is a perspective view of the head of the vertical portion of the handlebar with the collet inserted.

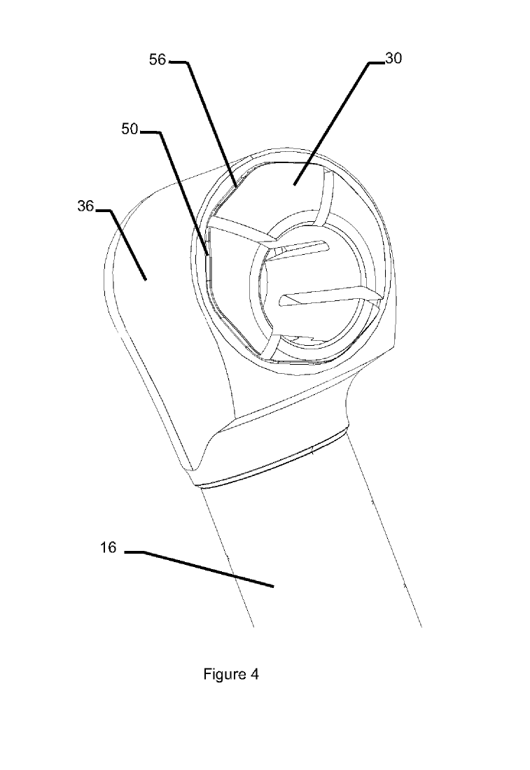

FIG. 5 is a perspective view of the bolt plate.

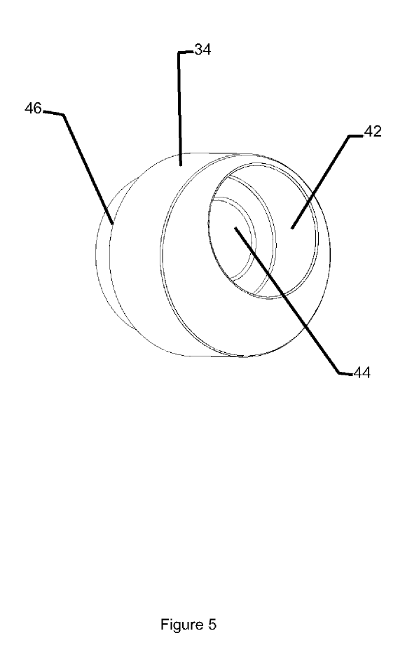

FIG. 6 is a perspective view of the assembled bolt plate on the horizontal portion of the handlebar.

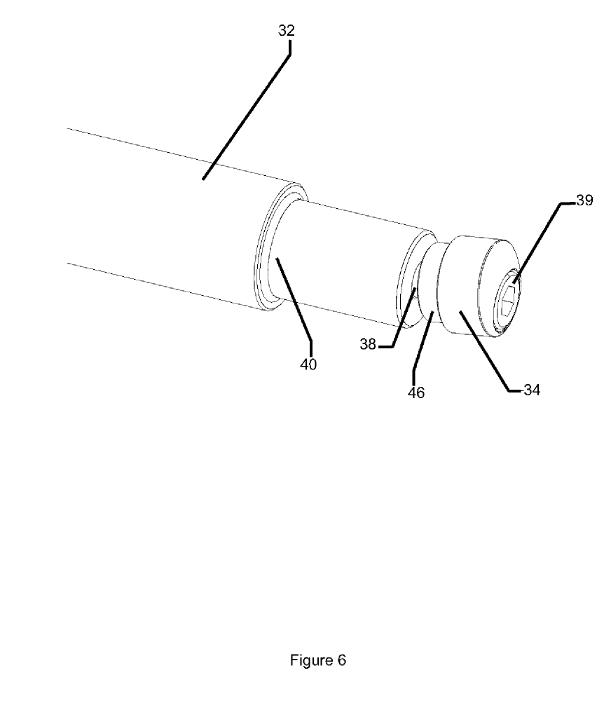

FIG. 7 is an expanded view of the vertical and horizontal portions of the handlebar with the bolt, collet and bolt plate.

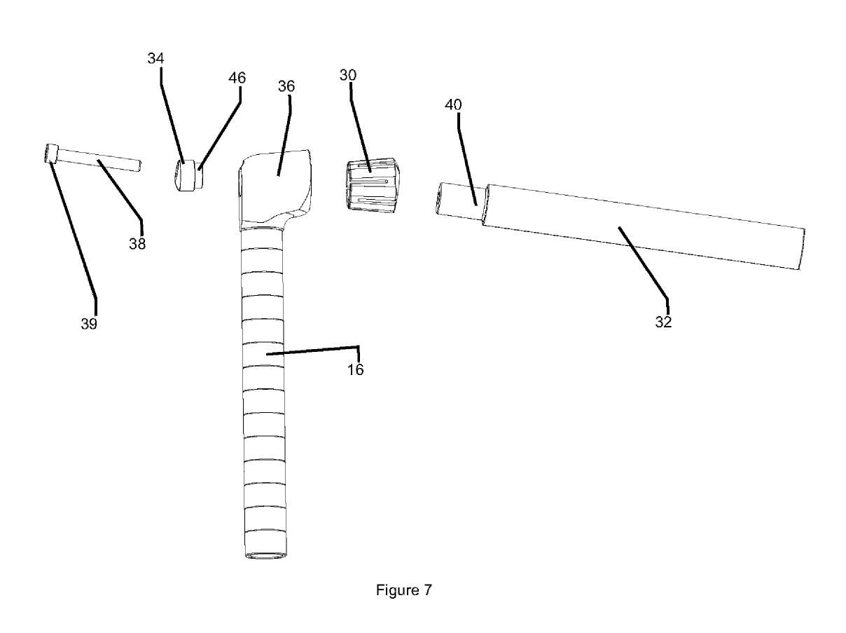

### DESCRIPTION OF THE PREFERRED EMBODIMENTS

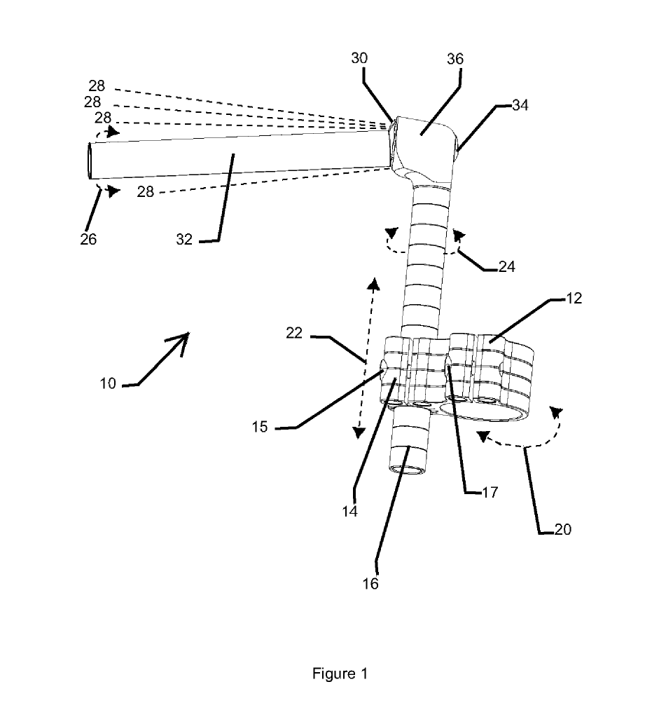

A handlebar 10 is shown in FIG. 1 having various angular settings 28 which vary from a straight horizontal position. A straight horizontal position may also be selected. The generally L-shaped handlebar 10 has a vertical portion 16 which is adjustable up and down as shown by arrows 22 relative to handle bar split ring clamp 14. The vertical portion 16 of the handlebar 10 is also adjustable by rotation along arrows 24 by loosening and then tightening adjustment bolt 15 on handle bar split ring clamp 14. The position of the vertical portion 16 of the handlebar 10 may be adjusted angularly by rotation as shown by arrows 20 about a fork tube of a vehicle such as a motorcycle, bicycle or other vehicle by tightening or loosening adjustment bolt 17 on fork split ring clamp 12. Thus the position of the vertical portion 16 of the handle bar 10 is adjustable to a desired position relative to the rider on the vehicle. Between the adjustments of the collet 30 in the tapered head 36 and the angular adjustments of the vertical portion 16 of the handlebar 10 in the handle bar split ring clamp 14 the handle bar horizontal portion 32 can be placed at the desired angle relative to the horizontal and at the desired angle relative to the vehicle center line.

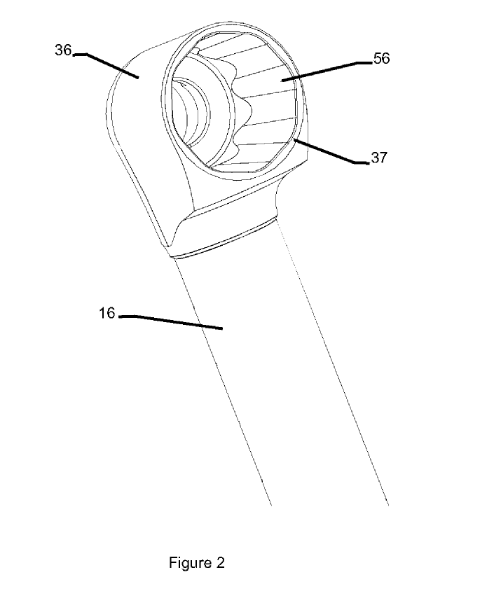

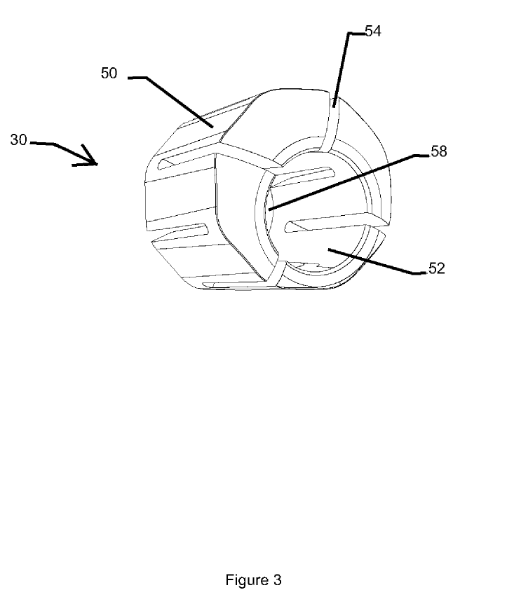

As shown in FIG. 2 the tapered head 36 at the end of the vertical portion 16 of handle bar 10 has inside diameter flats 56 for securing collet 30 at preset positions. As shown in FIG. 3 collet 30 has flats 50 on its outer diameter which compliment the flats 56 on the inside diameter of tapered head 36. Collet 30 has a plurality of slots 54 between the flats 50 allowing the collet 30 to be squeezed onto and thereby grip the shoulder portion 40 of handlebar horizontal portion 32 when installed in tapered head 36. Bolt 38 passing thorough bolt plate 34, tapered head 36, collet 30 and shoulder portion 40 threads into handlebar horizontal portion 32 to lock the handlebar horizontal portion 32 into position in the tapered head 36. The angle of the handlebar horizontal portion 32 can be easily and quickly changed by turning the head 39 of bolt 38 to loosen the handlebar horizontal portion 32 to remove the collet 30 from the tapered head 36 and reposition the collet 30 relative to the tapered head 36 to adjust the angle of the handlebar horizontal portion 32 relative to tapered head 36. The number of flat portions 50 in the collet 30 and flat portions 56 on the tapered head 36 can vary.

As seen best in FIG. 3 the aperture 58 through the collet 30 is angled offset to allow the angle of the handlebar horizontal portion 32 to vary as the collet 30 is removed, repositioned and reinserted in the tapered head 36.

The inside diameter 52 of the collet 30 may be round or any other shape to match the shape of the outside diameter of the shoulder 40 of the handlebar horizontal portion 32.

The bolt plate 34 preferably has an aperture 42 for receiving the bolt head 39 on bolt 38 and an aperture 44 for allowing the shaft of bolt 38 to pass through the remaining portion of the bolt plate 34. The apertures 42 and 44 are off center to complement the angled offset nature of the collet 30 allowing the bolt 38 to engage the horizontal portion 32 of the handlebar 10 and be threaded therein while centered therein.

The inside walls having flat portions 56 of head 36 are tapered to a smaller diameter as the walls go in from the mouth 37 of the tapered head 36 to tighten the collet 30 on the shoulder 40 of the handlebar horizontal portion 32 as the bolt 38 is tightened. Shoulder 46 on bolt plate 34 seats in a corresponding aperture in tapered head 36 to help align the parts during assembly and hold them in place when assembled.

When assembled the handlebar horizontal portion 32 will be held in place such that it will not rotate out of angular alignment and can be set at predetermined angles quickly and easily by simple adjustments.

Obviously, many modifications and variations of the present invention are possible in light of the above teachings. It is therefore to be understood that, within the scope of the appended claims, the invention may be practiced otherwise than as specifically described.

1-6. (canceled)

7. An adjustable handlebar comprising:
(a) a handlebar portion having a shoulder portion at one end with internal threads;
(b) a collet having a first end, a second end and a wall portion between the first end and the second end, said wall portion having an outer surface portion centered about a first longitudinal axis and an inner surface portion defined by an aperture centered about a second longitudinal axis for receiving the shoulder portion of the handlebar portion and wherein said aperture is angularly offset in that the first longitudinal axis and the second longitudinal axis are not parallel to each other;
(c) a bolt having a head at one end and external threads at the other end;
(d) a bolt plate having a shoulder and an aperture through which the threaded end of the bolt passes but not the head of the bolt, the shoulder and aperture of the bolt plate oriented to complement the angularly offset aperture of the collet;
(e) a member having a first opening for receiving the collet and a second opening in communication with the first opening for receiving the shoulder of the bolt plate, the first opening interacting with the collet permitting the angle at which the handlebar portion extends from the member to be adjusted to a desired angle and the second opening interacting with the bolt plate so the threaded end of the bolt can pass through the bolt plate and then mate with the internal threads of the handlebar portion to secure the handlebar portion to the member at the desired angle.

8. The adjustable handlebar assembly of claim 7 wherein the collet has a plurality of first flats and the member has a plurality of second flats.

9. The adjustable handlebar assembly of claim 8 wherein the collet has at least one slot.

10. The adjustable handlebar of claim 7 wherein said handlebar portion is a horizontal handlebar portion and said member is a vertical handlebar portion.

11. An adjustable handlebar comprising:
(a) a handlebar portion having a shoulder;
(b) a collet having an outer surface portion and an aperture shaped to receive the shoulder of the handlebar portion so that the handlebar portion extends from the collet at an angle other than 180° to the collet's outer surface portion;
(c) a member having an aperture shaped to receive the collet so the handlebar portion extends from the member at a selected, but adjustable angle; and
(d) means in addition to the collet for fastening the handlebar portion to the member at the selected angle wherein said means for fastening includes a member directly connected to the handlebar portion.

12. The adjustable handlebar of claim 11 wherein the means for fastening the handlebar portion and collet to the member comprises a bolt plate and a bolt.

13. The adjustable handlebar of claim 11 wherein the collet has a plurality of first flats and the wall of the aperture of the member has a plurality of second flats.

14. The adjustable handlebar of claim 13 wherein the collet has a slot between at least one adjacent pair of first flats.

15. The adjustable handlebar of claim 11 wherein the means for fastening the handlebar portion and collet to the member comprises a bolt plate having a first end, a second end and an outer wall portion between the first end and the second end centered about a first longitudinal axis and a bolt-receiving aperture centered about a second longitudinal axis which is not parallel to the first longitudinal axis.

16. An adjustable handlebar of claim 11 wherein:
the aperture of the member is defined by a wall having an inside taper with a plurality of flat faces along the wall,
the collet has a plurality of flat faces on its outer surface corresponding to the flat faces of the wall of the aperture of the member, the collet having slots between its flat faces,
the handlebar portion has an aperture centered therein, and
the means for fastening the handlebar portion to the member includes a bolt plate having an aperture therethrough, and a bolt passing through the aperture of the bolt plate and into the member to engage the horizontal handlebar aperture; said bolt plate and bolt cooperating to pull the horizontal handlebar and collet toward the bolt plate thus compressing the handlebar and collet inside the aperture of the member to secure the handlebar portion to the member at a desired angle.

17. An adjustable handlebar as in claim 11 wherein the member is a second handlebar portion.

18. An adjustable handlebar as in claim 11 further comprising:
a dual split ring clamp secured to the member.

19. An adjustable handlebar as in claim 18 wherein the dual split ring clamp adjustably engages the member for height and rotational adjustment of the member.

20. A method for attaching a handlebar portion having a first set of threads to a member at a selected angle comprising:
(a) inserting one end of the handlebar portion into an aperture of a collet, said collet having a first end, a second end, an outer surface portion between the first end and the second end, and an aperture, the aperture of the collet being oriented with respect to the outer surface portion of the collet so the handlebar portion extends from the collet at an angle to the outer surface portion rather than parallel to the outer surface portion of the collet;
(b) inserting the collet into an aperture of the member so the handlebar portion extends from the member at a selected but adjustable angle;
(c) using a plate having an aperture and a threaded fastener having threads which cooperate with the first set of threads of the handlebar portion to lock the handlebar portion to the member.

21. The method of claim 20 wherein said threaded fastener is a bolt.

22. The method of claim 20 wherein the aperture of the collet is defined by a wall having a first set of flats and the aperture of the member is defined by a wall having a second set of flats.

23. The method of claim 22 wherein said collet includes a slot between two adjacent flats.
